(19) United States
(12) Patent Application Publication
(10) Pub. No.: US 2016/0006046 A1
(43) Pub. Date: Jan. 7, 2016

(54) Elastomeric End Frame of a Redox Flow Battery

(71) Applicant: CELLSTROM GMBH, Klaus (AT)

(72) Inventors: HERBERT BUCSICH, KLINGENBACH (AT); MARTIN HARRER, WIEN (AT); PETER POKORNY, WIEN (AT); MARKUS TRAMPERT, WIEN (AT); ADAM WHITEHEAD, EISENSTADT (AT)

(73) Assignee: CELLSTROM GMBH, Klaus (AT)

(21) Appl. No.: 14/771,391

(22) PCT Filed: Feb. 21, 2014
(86) PCT No.: PCT/EP2014/053429

§ 371 Date: Aug. 28, 2015

(30) Foreign Application Priority Data
Mar. 1, 2013 (AT) A50136/2013

(51) Int. Cl. H01M 8/02; H01M 8/20; H01M 8/24; H01M 8/18

(52) U.S. Cl. CPC H01M 8/0273; H01M 8/188; H01M 8/20; H01M 8/24

(57) ABSTRACT

In order to improve the sealing between an elastomeric end frame (20) and the adjacent stack frame (3) of a cell stack (4) of a redox flow battery, it is provided that on the side of the recess (22) to receive a current collector (21) a first sealing element (25), which extends along the periphery of the end frame (20), is closed in the peripheral direction and protrudes from the first end face (24) of the end frame (20), is integrally molded on a first end face (24) of the end frame (20).

The present invention relates to an elastomeric end frame of a redox flow battery with a central first recess to receive a current collector and a radially outer frame with a first end face which surrounds the central recess, and a cell stack with such an end frame.

It is known that redox flow batteries consist of cells through which electrically differently charged electrolytes flow. The cells comprise two frames which are lined up alongside one another, in each of which an electrode is arranged and which are separated by a semipermeable membrane, typically an ion exchange membrane. A bipolar plate is arranged between individual cells of the redox flow battery. However, in the end frame at the axial ends of the redox flow battery there is no electrode arranged as in the cells, but a metallic current collector which is connected to an outwardly led electrical connection of the redox flow battery. The individual frames of the redox flow battery must be sealed with respect to one another, in order on the one hand to prevent electrolyte from escaping outwards (external sealing), and on the other hand in order to prevent the differently charged electrolytes from mixing (internal sealing), which would cause a loss of efficiency. However, leakages in the region of the metallic current collector are problematic, since an electrolyte would inevitably cause corrosion on the current collector, which after a certain time would lead to the total failure of the redox flow battery. Therefore, a contact between the electrolyte and the metallic current collector is to be prevented.

Two types of frames are used in redox flow batteries, namely frames made of elastic plastics (elastomers) and non-elastic plastics, such as for example PVC, PP, PE, PTFE, epoxy resin, etc. Non-elastic plastics, typically thermoplastic plastics, are stiff and can only be molded within a certain temperature range. Elastomers are rigid but resiliently deformable plastics, i.e. an elastomer returns to its original shape after deformation.

Sealing elements, such as for example O-rings, which are arranged between stiff frames and produce a seal by the pressing together of the frames, are generally used for sealing between stiff frames made of non-elastic plastics. For this purpose the sealing elements are generally arranged in grooves on the end faces of the frames. Examples for such frames can be found in EP 1 411 576 A1 or WO 2004/079849 A1. The problem here is that the stiff frames can be mechanically damaged relatively easily, for example by scratches on the surface. It has been shown that small scratches are already sufficient to have a lasting adverse effect on the sealing. Such seals are also sensitive to foreign bodies (hairs, fibers, etc.) on the frames which in interaction with the sealing elements can again lead to leakages. In addition, the assembly of a redox flow battery is rendered difficult by the large number of necessary sealing elements which can be easily displaced and jammed.

Frames made of non-elastic plastics have also already become known which have peripheral raised ribs which are formed on an end face and which engage positively for sealing in grooves in the adjacent end face. Such frames are known for example from U.S. Pat. No. 4,640,876 A or U.S. Pat. No. 6,086,643 A. With regard to the sealing effect, also such frames are very susceptible to the slightest damage to the surfaces. However, the manufacturing tolerances during production, generally by injection molding, of the frames is a further problem of such frames. In this connection manufacturing tolerances of +/−1% are usual. As a result, however, alignment errors occur between ribs and associated grooves, in particular if a plurality of ribs are provided, which in turn can lead to leakages between the frames.

In elastomeric stack frames with integrally molded raised sealing elements, such as sealing ribs, two differently constructed stack frames would be needed in order to prevent a sealing element from abutting a sealing element in the assembled state, which in turn would bring problems with the exact alignment of the sealing elements. In the case of abutting sealing elements, due to the deformation of the sealing elements during assembly the problem would also arise of sealing elements potentially crossing over one another. In addition, also in the case of elastic stack frames problems would be encountered with foreign bodies (hairs, fibers, etc.) on the sealing surfaces or minor damage (scratches). Therefore during assembly the stack frames would have to be examined very accurately for damage or foreign bodies, which would significantly increase the assembly costs. However, all these problems would also lead back again to a higher susceptibility of a cell stack to leaks. Moreover, that would also increase the complexity of the assembly of a redox flow battery, since more different individual parts are required, which ultimately also increases the susceptibility to errors during assembly. For these reasons in principle no elastomeric frames with integrally molded raised sealing elements are used.

For these reasons the properties of the elastomeric material are exploited for the production of a seal, by pressing together the flat end faces of the abutting stack frames and thereby producing a seal between the stack frames. Such stack frames have become known for example from AT 501 902 A1 and AT 501 903 A1. The advantage here is that the sealing is produced by the abutting end faces themselves and as a result no further sealing elements or raised ribs are required. Moreover, such an elastomeric stack frame with sealing end faces is more insensitive to damage to the surface. However, here too, the manufacturing tolerances cause difficulties in the production of the frames. Sealing must be provided between two stack frames with respect to the electrode plate, for the internal sealing, and with respect to the adjacent stack frame, for the external sealing of the redox flow battery. However, because of the manufacturing tolerances reliable sealing cannot be provided simultaneously on both sealing surfaces. Due to the dimensions of the stack frame, however, emphasis can be placed on the internal or the external sealing effect, by setting more contact pressure between the electrode plates and the stack frame or between the two stack frames due to the dimensions of the stack frame. Priority is usually given to the external sealing, since internally a slight leakage between the stack frame and the electrode plate does not constitute a major problem. However, this is not possible between stack frame and the end frame of the redox flow battery, since such an internal leakage of electrolyte liquid would destroy the metallic current collector in the end frame by corrosion.

It is therefore an object of the present invention to create a seal between the end frame and the adjacent frame of a cell stack of a redox flow battery, which seal provides reliable sealing both internally and also externally.

This object is achieved in that on the side of the recess to accommodate a current collector a first sealing element, which extends along the periphery of the end frame, is closed in the peripheral direction and protrudes from the first end face of the frame, is integrally molded on the first end face. Thus for the end frame the disadvantages due to the greater cost for assembly (brought about by the necessity of an accurate inspection of the end frame for damage on the surface or foreign bodies) are accepted, since by the sealing element a seal is created which reduces the probability of electrolyte liquid coming into contact with the current collector. Outwardly the sealing takes place as always by the abutting end faces of the elastic end frame and stack frame.

If a peripheral raised portion with a second end face is provided on the end frame on the radially external edge, and a second sealing element, which extends along the periphery of the end frame, is closed in the peripheral direction and protrudes from the second end face of the frame, is integrally molded on the second end face, the external sealing effect can be additionally increased. Moreover, the sealing effect is no longer influenced, or only influenced insignificantly, by production tolerances of the end frame or stack frame.

The sealing effect can be further improved by the provision of a plurality of sealing elements on the first end face or on the second end face.

The present invention is explained in greater detail below with reference to FIGS. 1 to 6, which show by way of example, schematically and without limitation, advantageous embodiments of the invention, in the drawings:

FIG. 1 shows a redox flow battery with a cell stack,

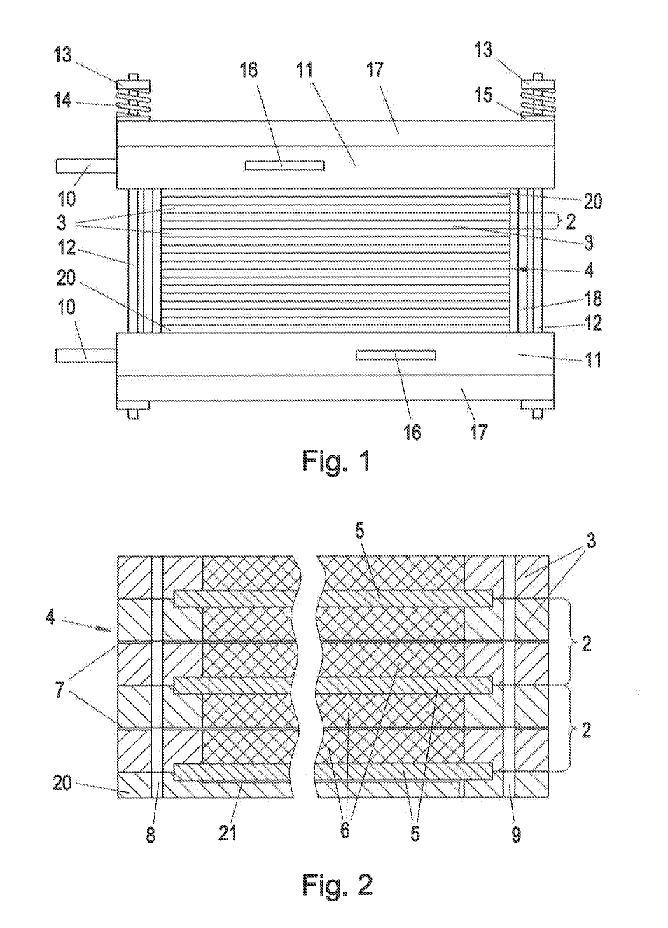

FIG. 2 shows a section through the cell stack,

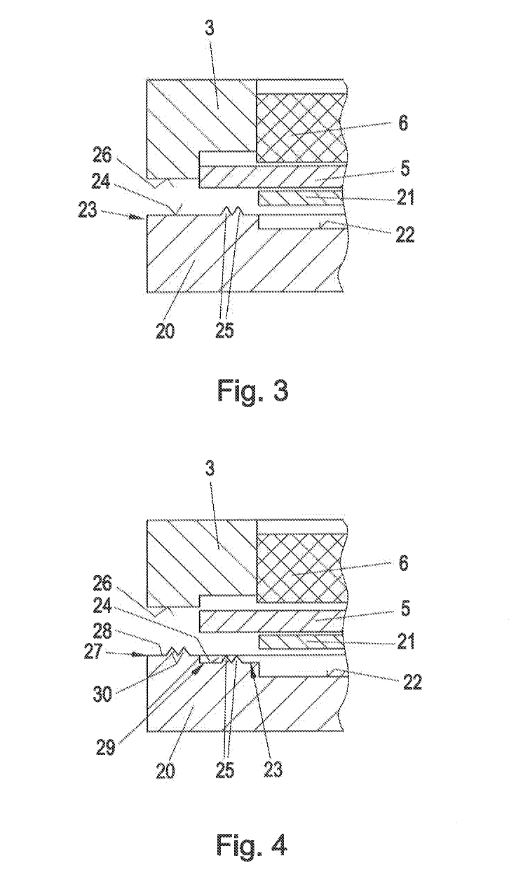

FIGS. 3 and 4 show detail views of the end frame and of the adjacent stack frame,

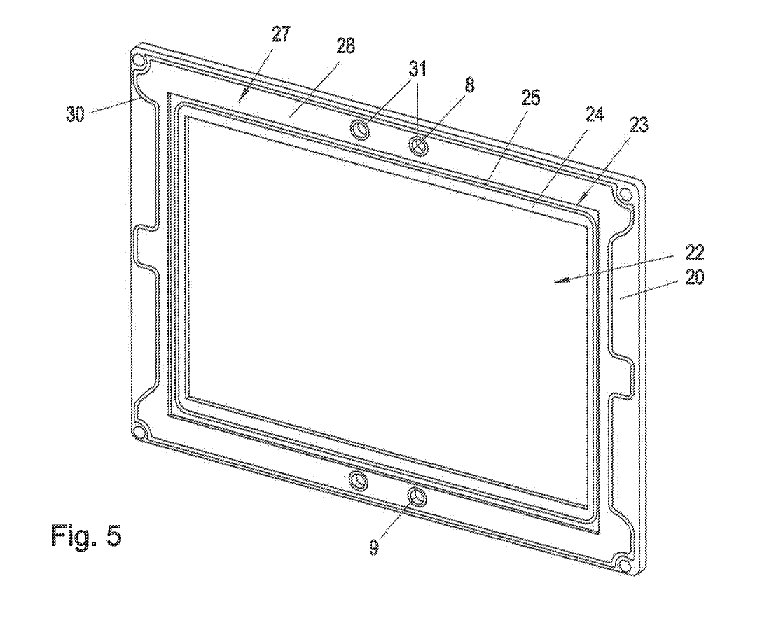

FIG. 5 shows a perspective view of an end frame according to the invention, and

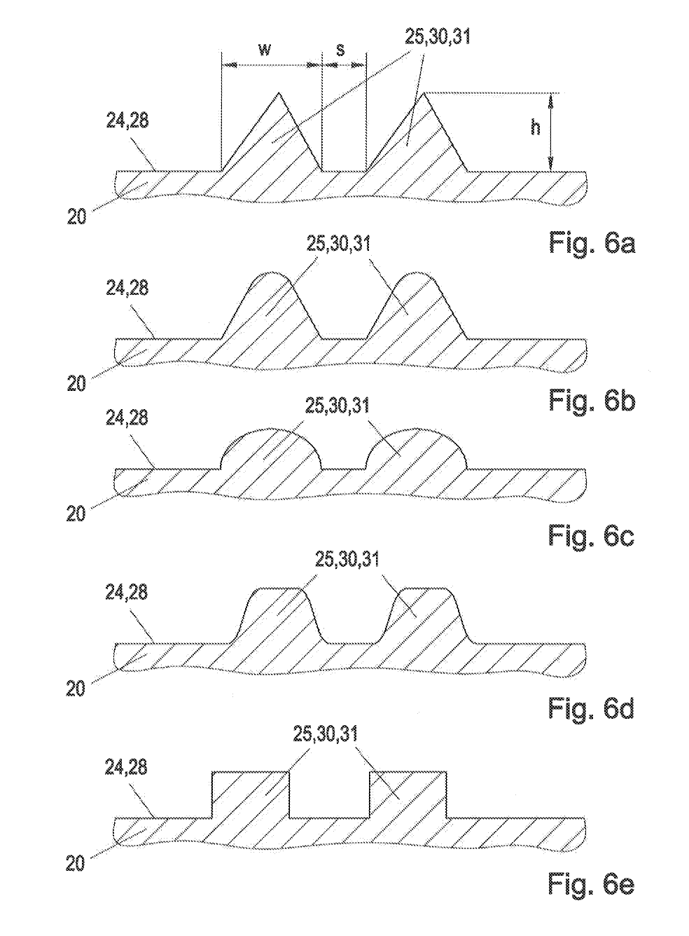

FIG. 6 shows possible cross-sections of the sealing elements on the end frame.

The structure of a redox flow battery 1 is explained with reference to FIGS. 1 and 2. A cell stack 4 of a redox flow battery 1 comprises a plurality of cells 2, which in turn are in each case formed of two stack frames 3. A stack frame 3 is manufactured from an elastomer, such as for example a polyolefinic thermoplastic elastomer (TPE or TPO), such as for example Santoprene®, or a thermoplastic vulcanizate (TPV), in particular in an injection molding process. The frame material has for example a hardness in the range of 40-95 Shore A, preferably 60-75 Shore A. A semipermeable membrane 7, typically an ion exchange membrane (either a cation or anion exchange membrane, for example Nafion®) is disposed in each case between two stack frames 3 of a cell 2. An electrode plate 5, for example a bipolar plate, is arranged between two adjacent cells 2, wherein the electrode plate 5, as shown here, can be inserted in recesses in the stack frame 3. The stack frames 3 have central through openings, in which in each case electrodes 6, for example mats made of carbon fibers, are arranged. Electrically differently charged electrolyte liquids are pumped through the cells 2 via bores 8, 9 in the stack frames 3, wherein another electrolyte liquid flows through the electrodes 6 of each half-cell of a cell 2. The electrolyte liquids can be supplied from and discharged to the exterior via electrolyte liquid connections 10 and are then distributed internally via a channel system. In this way, as is well known, electrochemical processes lead to the generation of electrical current or charging of the redox flow battery 1, or more precisely the electrolyte liquids.

The sealing between the stack frames 3 takes place by means of the abutting end faces of the stack frames 3. Since the stack frames 3 are manufactured from an elastomer and consequently are elastic, the sealing between the stack frames 3 or cells 2 is effected at a sufficient pressure.

The cell stack 4 is disposed between two rigid end plates 11 and is compressed by clamping means, such as for example bolts 12 which extend therethrough, which are secured by means of nuts 13, washers 15 and springs 14. Furthermore an electrical connection 16, by means of which the redox flow battery 1 can be connected to an external current circuit, can be provided on the end plates 11. Furthermore, connections 10 for supplying and discharging the electrolyte liquid are provided on the end plates 11. The two end plates 11 here are also arranged between two pressure plates 17 which are compressed by the clamping means. Naturally, any other suitable clamping means can be used. In order to prevent settling of the elastic stack frame 3 due to the contact pressure, a stop or spacer 18 may also be provided between the end plates 11. Instead of the end plate 11 and the pressure plate 17, naturally it is also possible to use only one single plate.

The cell stack 4 is closed at the two axial ends in each case by an end frame 20 which abuts the end plate 11. A metallic current collector 21 which is connected to an electrical terminal 16 is arranged in the end frame 20, for example in a recess on an end face of the end frame 20, The current collector 21 is made for example of copper or aluminum, possibly with an external coating with an electrically conductive material. The coating is for example made of Zn, Sn, Ni, Pb, Sb, Cd, Cr, C, In or an alloy thereof. Likewise inorganic compounds, such as for example oxides, hydroxides, carbides, phosphides, sulfides, borides, etc., or electrically conductive polymers are conceivable as the coating. Intermediate layers, for example of Ni, are also possible between the coating and the base material. A current collector 21 could for example be produced from 200 μm aluminum with an intermediate layer of 5 μm Ni and an external coating of 10-100 μm Sn. The end frame 20 is described in greater detail below with reference to FIG. 3.

The end frame 20 has a first central recess 22 in which the current collector 21 is arranged. Around the central first recess 22 the end frame 20 forms a radially outer frame 23 with a first end face 24 on the side of the first recess 22 facing the adjacent stack frame 3. A first sealing element 25, which extends along the periphery of the end frame 20, is closed in the peripheral direction and protrudes out of the first end face 24, is integrally molded on the first end face 24 of the frame 23 or of the end frame 20. “Integrally molded” here means that the sealing element 25 is an integral part of the end frame 20 and in the shaping process (for example injection molding) of the end frame 20 is formed together therewith. Thus the sealing element 25 is preferably manufactured from the same material as the end frame 20. In the exemplary embodiment shown, two such sealing elements 25 are disposed adjacent to one another. In the assembled cell stack 4 this first sealing element 25 co-operates with the electrode plate 5 of the adjacent cell 2 to form a seal by the action of the contact pressure. The sealing element 25 is elastically deformed by the contact pressure and thus forms an effective seal between the electrode plate 5 and the end frame 20, which prevents internal leakage and thus prevents electrolyte liquid from coming into contact with the current collector 21. Furthermore, the first end face 24 can co-operate in a sealing manner with the opposite end face 26 of the adjacent stack frame 3, in order also to create an external seal which prevents electrolyte liquid from escaping outwards from the cell stack 4.

Another advantageous embodiment of the seal between the end frame 20 and the adjacent stack frame 3 is described with reference to FIGS. 4 and 5. In this case, on the side of the first recess 22 on the external edge of the end frame 20 or of the frame 23, a raised portion 27 running around the periphery of the end frame 20 is provided with a second end face 28. In this way the end frame 20 is designed with a central first recess 22 to accommodate the 20 current collector 21 and, radially outside the first recess, with a second recess 29 with the end face 24 to accommodate the electrode plate 5 of the adjacent cell 2. A second sealing element 30, which extends along the periphery of the end frame 20, is closed in the peripheral direction and protrudes out of the second end face 28, is integrally molded on the second end face 28 of the end frame 20. In the exemplary embodiment shown, two such sealing elements 30 are disposed adjacent to one another. In the assembled cell stack 4 this second sealing element 30 co-operates with the opposing end face 26 of the adjacent stack frame 3 to form a seal by the action of the contact pressure. The sealing element 30 is elastically deformed by the contact pressure and thus forms an effective seal between the end frame 20 and the adjacent stack frame 3, which prevents an external leakage and thus an escape of electrolyte liquid outwards from the cell stack 4.

Likewise around the bores 8, 9 such sealing elements 31 could be provided on the first end face 24 or the second end face 28 in order to improve the sealing here, as illustrated in FIG. 5.

Conceivable cross-sectional shapes of the sealing elements 25, 30, 31 are illustrated in FIGS. 6a to 6e. The sealing elements 25, 30, 31 may for example be triangular (FIG. 6a), dome-shaped (FIG. 6b), semicircular or in the form of a segment of a circle (FIG. 6c), in the form of a flattened curve or a polygonal line (FIG. 6d), rectangular (FIG. 6e). A sealing element is preferably designed with a width w in the range from 0.1 to 10 mm and with a height h in the range from 5 to 500 μm. If a plurality of sealing elements 25, 30, 31 are arranged adjacent to one another, the distance s between them is preferably in the range from 0.5 to 30 mm.

1. An elastomeric end frame of a redox flow battery with a central first recess to receive a current collector and a radially outer frame with a first end face which surrounds the central recess, wherein on the side of the recess a first sealing element, which extends along the periphery of the end frame, is closed in the peripheral direction and protrudes from the first end face of the frame, is integrally molded on the first end face.

2. The elastomeric end frame according to claim 1, wherein a peripheral raised portion with a second end face is provided on the end frame on the radially outer edge, and a second sealing element, which extends along the periphery of the end frame, is closed in the peripheral direction and protrudes from the second end face, is integrally molded on the second end face.

3. The elastomeric end frame according to claim 1, wherein a plurality of sealing elements are formed on the first end face or on the second end face.

4. A cell stack of a redox flow battery with a plurality of abutting cells formed in each case of two adjacent stack frames, wherein adjacent cells are separated from one another by electrode plates, and with an end frame according to claim 1, wherein the end frame is arranged abutting the adjacent cell at the axial end of the cell stack, wherein the current collector in the end frame and the first sealing element abuts the electrode plate of the adjacent cell and the first end face of the end plate abuts the facing end face of the adjacent stack frame.

4. The cell stack according to claim 4, wherein the second sealing element abuts the facing end face of the adjacent stack frame.
